(19) United States
(12) Patent Application Publication
(10) Pub. No.: US 2016/0283980 A1
(43) Pub. Date: Sep. 29, 2016

(54) SHADOW ADVERTISEMENT SYSTEM AND METHOD, CONTROLLED IN LINKAGE WITH SMARTPHONE

(71) Applicant: Jaeyong Lee, Cheongju (KR)

(72) Inventor: Jaeyong Lee, Cheongju (KR)

(21) Appl. No.: 15/034,473

(22) PCT Filed: Nov. 8, 2013
(86) PCT No.: PCT/KR2013/010153

§ 371 Date: May 4, 2016

(30) Foreign Application Priority Data
Nov. 7, 2013 (KR) 10-2013-0134605

(51) Int. Cl. G06Q 30/02; G09F 13/00; G09F 13/20; G09F 19/18; G09F 19/22

(52) U.S. Cl. CPC G06Q 30/0261; G09F 19/18; G09F 19/22; G09F 13/20; G09F 13/005; G06Q 30/0264; G09F 2013/222

(57) ABSTRACT

Disclosed are a shadow advertisement system and a shadow advertisement method which are controlled in linkage with a smartphone. The system comprises: a power supply unit for, in DC-DC conversion of solar energy from a photovoltaic module, supplying a constant DC voltage and DC current or using an SMPS power source; a shadow advertisement controller for receiving, via a smartphone and a wireless communication means, an upload of an advertisement image and setting an advertisement time; and a shadow advertisement system for projecting a shadow advertisement printed on a film through a light source, a lens and an advertisement film in linkage with a lighting circuit and exposing the shadow advertisement, wherein the shadow advertisement is exposed at a certain location in such a manner that the light source is delivered to and penetrates the lens, and the advertisement printed on the advertisement film is projected by light which has passed through the lens.

### TECHNICAL FIELD

The present invention relates to a shadow advertisement system and a method thereof, and in particular to a shadow advertisement system and a method thereof which can be controlled in linkage with a smartphone, wherein electric power is supplied to a streetlight(LED lighting) with the aid of a SMPS electric power, a sunlight module and a charge controller, and a logo and advertisement image of an enterprise are uploaded using a smartphone to a controller of a shadow advertisement system, so a shadow advertisement is projected using a streetlight via a LED light source, a lens, an advertisement film made of a transparent material, whereupon a shadow advertisement containing a logo, brand and advertisement image of an enterprise can be conveniently provided at an outdoor space, for example, an exhibit hall, a streetlight, a bus stop, a shelter, etc.

### BACKGROUND ART

A streetlight, in general, is able to light for a vehicle to be driven in safe at night when the vehicle is driven on a road by lighting the road from the time when illumination becomes low in the evening. An advertisement board for advertising toward people in vehicles which are being driven on the road at day and night times or a traffic sign board for guiding road information is installed at the aforementioned streetlight. The advertisement board or the sign board installed at the conventional streetlight can be fixed by engaging, using a bolt and a nut, the advertisement board to a streetlight pole.

Moreover, a bus outside advertisement, a subway inside advertisement, a school inside advertisement and a theater advertisement which are being mainly used as a conventional outdoor advertisement, are limited to spaces.

The conventional streetlight is not equipped with a predetermined structure for adjusting the height or angle of an advertisement board fixed to a streetlight pole. For this reason, an advertisement surface of an advertisement board is installed fixed in a predetermined direction, so an advertisement effect is disadvantageously not promoted.

Furthermore, an advertisement board can be installed at a streetlight pole by setting an advertisement surface in consideration of a slanted surface, etc. of a road for the sake of easier advertisement to passing vehicles. In this case, it, however, may need to reinstall the advertisement board which has been once installed, so as to adjust the height or angle, which may cause a lot of inconvenience.

Moreover, when it needs to change the contents of the advertisement, an advertisement board installation work should be inevitably carried out again, which may result in increased work time and labor, for which an installation cost, consequently, may increase.

The Korean patent registration number 10-1324081 discloses a shadow advertisement system using a streetlight and a method thereof. It, however, does not disclose any system wherein electric power cannot be supplied from a sunlight module for the streetlight to provide a shadow advertisement containing a logo, brand and advertisement image of an enterprise, and it does not disclose any function for uploading an advertisement image from a smartphone to a shadow advertisement control device.

### DISCLOSURE OF INVENTION

Accordingly, it is an object of the present invention to provide a shadow advertisement system and a method thereof which can be controlled in linkage with a smartphone, wherein electric power is supplied to a streetlight(LED lighting) with the aid of a SMPS electric power, a sunlight module and a charge controller, and a logo and advertisement image of an enterprise are uploaded using a smartphone to a controller of a shadow advertisement system, so a shadow advertisement is projected using a streetlight via a LED light source, a lens, an advertisement film made of a transparent material, whereupon a shadow advertisement containing a logo, brand and advertisement image of an enterprise can be conveniently provided at an outdoor space, for example, an exhibit hall, a streetlight, a bus stop, a shelter, etc.

To achieve the above objects, there is provided a shadow advertisement system which is controlled in linkage with a smartphone, which may include, but is not limited to, an power supply unit for, in DC-DC conversion of solar energy from a photovoltaic module, supplying a constant DC voltage and DC current or using an SMPS power source; a shadow advertisement controller for receiving, via a smartphone and a wireless communication means, an upload of an advertisement image and setting an advertisement time; and a shadow advertisement system for projecting a shadow advertisement printed on a film through a light source, a lens and an advertisement in linkage with a lighting circuit and exposing the shadow advertisement, wherein the shadow advertisement is exposed at a certain location in such a manner that the light source is delivered to and penetrates the lens, and the advertisement printed on the advertisement film is projected by light which has passed through the lens.

The power supply unit uses a solar cell battery power supply unit or a SMPS power supply unit and is configured to operate in a hybrid method by means of the shadow advertisement controller.

The shadow advertisement controller controls the advertisement image to be uploaded from an external PC or the smartphone and to be stored, thus projecting an advertisement image at a set time, and the wireless communication means uses any wireless communication method selected among Wi-Fi, Bluetooth, and a wireless LAN.

The shadow advertisement controller may include a controller which controls the shadow advertisement to be projected; a wireless communication unit (Bluetooth, Wi-Fi, WLAN) which is connected to the controller and is able to wirelessly receive, based on the shadow advertisement controller, a shadow advertisement image and an advertisement time information from the smartphone via a wireless communication (Bluetooth, Wi-Fi, WLAN); a storage unit which is connected to the controller and is configured to store the shadow advertisement image and the advertisement time information which are uploaded from the smartphone; an electric power unit (a SMPS power unit) which is able to supply an AC power in the form of a DC power; and a timer which is connected to the controller and is configured to count time.

The shadow advertisement controller may include a CdS cell power driving unit (a CdS sensor) which is connected to the controller and is configured to automatically turn on the electric power of the streetlight if illuminance becomes low at an evening time and a deep night time or if the illuminance drops below a predetermined reference value of a constant illuminance value and turn off the electric power of the streetlight if the illuminance becomes higher than a predetermined illuminance value at a lunch time, and in this case the controller is configured to drive the light source driving unit in response to an on/off operation of the CdS cell power driving unit (a CdS sensor).

The shadow advertisement controller is connected to an external server via the wireless communication means and receives the advertisement image and the advertisement time information.

The shadow advertisement system may include a light source which is able to emit light; a lens which is fixed spaced apart by a predetermined distance from the advertisement film and has a predetermined radius of curvature; and an advertisement film which is made of a transparent material and is configured to converge the straight light from the light source at the lens and project the advertisement of the film, wherein the lens is any of a convex lens and a concave lens or a convex lens made of another material can be shaped on a plane lens or a curved lens, and if the advertisement of the advertisement film absorbs the light source and is dispersed on the lens, the advertisement printed on the advertisement film is projected via the light which has passed through the lens, thus exposing a shadow advertisement at a predetermined position.

To achieve the above objects, according to another embodiment of the present invention, there is provided a shadow advertisement system which is controlled in linkage with a smartphone which may include, but is not limited to, a light source which is able to emit light; an image cell which is connected to the light source, and a shadow advertisement controller which is configured to transmit an advertisement image information to the image cell for the advertisement image to be projected via the lens using the light source, wherein a beam projector is installed at a streetlight, and the advertisement image information is exposed in the form of a shadow advertisement image at a predetermined position with the aid of the light source.

To achieve the above objects, there is provided a shadow advertisement method which is controlled in linkage with a smartphone, which may include, but is not limited to, a step wherein an advertisement information containing an advertisement image and/or an advertisement time and position of a member is received by a shadow advertisement controller from a smartphone or a computer via a wireless communication unit, and the thusly received information is stored; and a step wherein an advertisement image information printed on an advertisement film made of a transparent material projected via the light source and the lens by means of the shadow advertisement controller and the shadow advertisement system is projected via the light which has passed via the lens, thus exposing the shadow advertisement image at a predetermined position.

The aforementioned method further include a step wherein an advertisement member subscription information is transmitted from the smartphone or the computer to an advertisement server via the wireless communication unit, and a login is carried out.

### ADVANTAGEOUS EFFECTS

In the shadow advertisement system and the method thereof which are controlled in linkage with a smartphone according to the present invention, electric power is supplied to a streetlight(LED lighting) with the aid of a SMPS electric power, a sunlight module and a charge controller, and a logo and advertisement image of an enterprise are uploaded using a smartphone to a controller of a shadow advertisement system, so a shadow advertisement is projected using a streetlight via a LED light source, a lens, an advertisement film made of a transparent material, whereupon a shadow advertisement containing a logo, brand and advertisement image of an enterprise can be conveniently provided at an outdoor space, for example, an exhibit hall, a streetlight, a bus stop, a shelter, etc., and it can be used in such a way to project on a floor surface or a wall surface of a large size mart, a building parking lot of a department store, a direction indication lamp inside a building, a company guide device, etc.

The shadow advertisement system and the method thereof according to the present invention are able to promote a LED lighting market while directly entering a conventional outdoor advertisement market by conveniently advertising a logo and brand of an enterprise printed on a transparent advertisement film, and are able to continuously provide an advertisement effect by periodically projecting, toward a shadow advertisement system, an advertisement data which can be automatically and wirelessly updated using a smartphone.

Moreover, the principle of the technology of the present invention may be employed to a home fluorescent lamp or a stand lamp in order to provide a smooth and advanced shadow advertisement by exposing a logo, a text or an advertisement image, so it is possible to provide an enhanced service function to a lighting device that a customer is using, in a shadow advertisement light market equipped with new lighting devices.

### BRIEF DESCRIPTION OF DRAWINGS

FIG. 1 is a view illustrating the configuration of a shadow advertisement system using a streetlight.

FIG. 2 is a view illustrating the configuration of a shadow advertisement system formed of a light source, a lens and an advertisement film according to a first embodiment of the present invention.

FIG. 3 is a view illustrating a shadow advertisement system using a controller.

FIG. 4 is a view illustrating the configuration of a shadow advertisement system wherein the electric power of a streetlight is driven by a sunlight module and a charge controller, and an advertisement image is uploaded from a smartphone according to a second embodiment of the present invention.

FIG. 5 is a view illustrating the configuration of a shadow advertisement system wherein the electric power of a streetlight is driven by a sunlight module and a charge controller, and an advertisement image is uploaded from a smartphone according to a second embodiment of the present invention.

FIGS. 6 and 7 are views illustrating a shadow advertisement display device implemented with a product which is equipped with a shadow advertisement controller and a shadow advertisement system.

FIG. 8 is a view illustrating the configuration of a sunlight streetlight which is driven by a solar battery module.

### BEST MODES FOR CARRYING OUT THE INVENTION

The configuration and operation of the preferred embodiments of the invention will be described in detail with reference to the accompanying drawings.

The shadow advertisement system according to an embodiment of the present invention will be described using a streetlight, but it is not limited thereto. It may be used in such a way to project on a floor surface or a wall surface of an exhibit hall, a bus stop, a shelter, an outdoor advertisement board, a large size mart, a building parking lot of a department, a direction indication lamp inside a building or a company guide device.

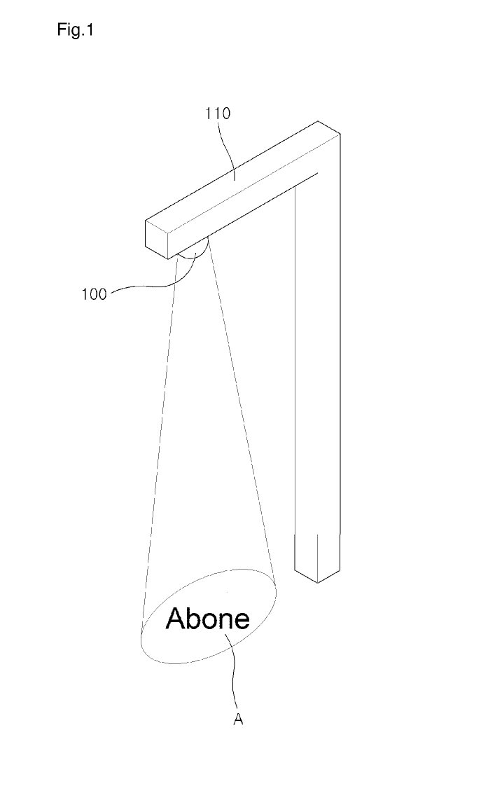

FIG. 1 is a view illustrating the configuration of a shadow advertisement system using a streetlight.

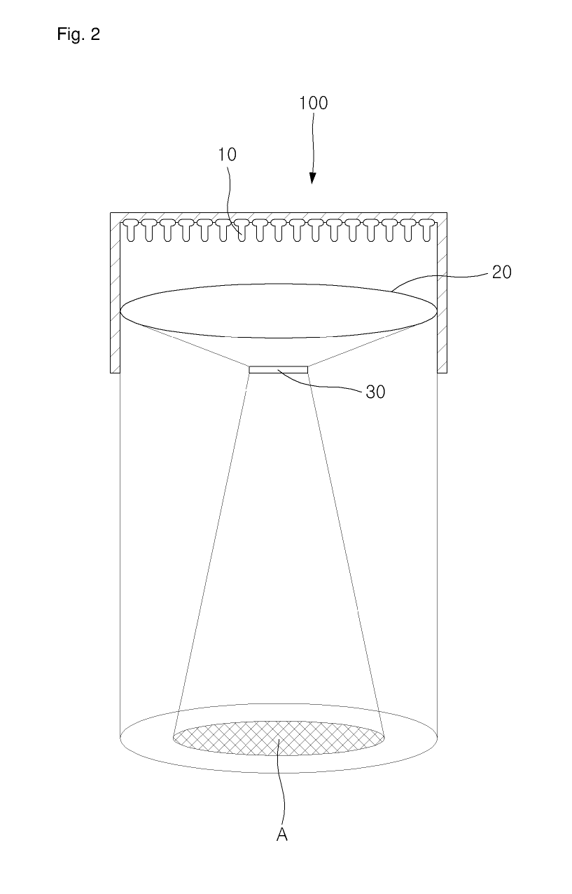

FIG. 2 is a view illustrating the configuration of a shadow advertisement system which includes a light source, a lens, and an advertisement film.

As illustrated in FIGS. 1 to 3, the shadow advertisement system using a streetlight according to the present invention may include, but is not limited to, a light source 10 which is able to emit light; a lens 20 which is fixed spaced apart by a predetermined distance from an advertisement film 30 and has a predetermined radius of curvature, and an advertisement film 30 which is made of a transparent material and is able to project an advertisement of a film in such a way to condense on a lens a straight light from the light source 10. The lens 20 may be formed of any of a convex lens and a concave lens or a convex lens made of another material may be shaped on a plane lens or a curved lens. If an advertisement printed on the transparent material advertisement film 30 absorbs a light from the light source and is dispersed on the lens, the advertisement printed on the advertisement film 30 is projected via the light which has passed through the lens, thus exposing a shadow advertisement image “A” at a predetermined position.

Referring to FIG. 2, the shadow advertisement system using a streetlight according to the present invention may include a light source 10 which uses a streetlight light source or a LED light source, an advertisement film 30 and a lens 20. There is provided a streetlight 100 which is equipped with a cover, etc. for protect the light source, the advertisement film 30 and the lens 20.

The light source 10 is a device for emitting light and is connected to a lighting driving circuit and may be any of a lamp, a light emitting lamp, a LED, etc.

The lens 20 is a lens which is fixed spaced apart by a predetermined distance from the advertisement film 30 and has a predetermined radius of curvature and may be any of a convex lens, a concave lens, etc. and may be made by shaping a convex lens made of another material on a plane lens or a curved lens.

The advertisement film 30 may be a film made of a transparent material and is able to project an advertisement of a film by condensing, on a lens, a straight light from a light source, for example, a lamp, a light emitting lamp, a LED, etc. In case of an OHP film, the heat resistance property of such an OHP film can be enhanced by coating an aerogel, etc. which is a heat resistance material, on the surrounding of a glass membrane of the light source. A transparent aerogel, etc. may be directly used as an advertisement film 30.

If the advertisement of the advertisement film 30 is projected via the light source 10 and is dispersed on the lens 120, the advertisement printed on the advertisement film 30 may be projected via the light which has passed through the lens 20, thus being exposed at a predetermined position, so the logo, brand and advertisement image of a predetermined enterprise can be conveniently advertised at an outdoor place.

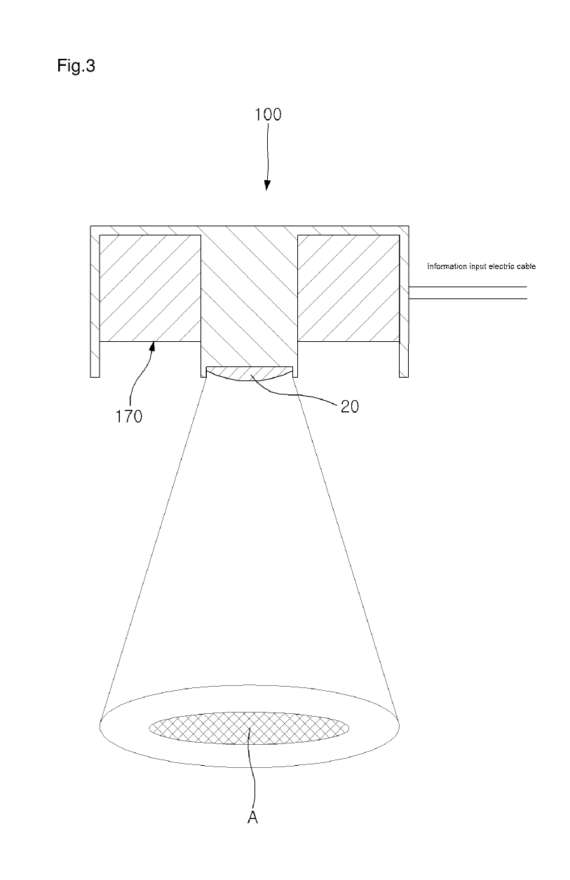

FIG. 3 is a view illustrating a shadow advertisement system using a controller.

If a shadow advertisement controller 170 which is able to provide a small sized beam projector function to a streetlight according to a first embodiment of the present invention, is used, the shadow advertisement system using a streetlight may include a light source 10 which is able to emit light, an image cell which is connected to the light source 10, and a controller 170 which is able to adjust the angle and advertisement position so as to project the advertisement of the image cell via the lens 20 using the light source 10 and continuously transmit an advertisement image information based on the advertisement information via a predetermined communication unit, namely, an advertisement image information of the image cell.

In order for the advertisement image information to be exposed at a predetermined place with the aid of the light source 10, the shadow advertisement controller may operate in linkage with a smartphone using a wireless communication unit, for example, Wi-Fi, Bluetooth, WLAN, etc. For example, a piconet may be configured via a Bluetooth paring, whereby an advertisement image information containing a member's advertisement time/position and an image information can be received via a wireless communication unit, whereupon the advertisement image information based on the advertisement information, namely, the advertisement image, can be preferably received externally from a smartphone via a wireless communication unit, for example, Wi-Fi, Bluetooth, a wireless LAN (WLAN).

In the shadow advertisement system controlled in linkage with a smartphone according to the present invention, electric power is supplied to a streetlight with the aid of a SMPS electric power, a sunlight module and a charge controller, and a logo and advertisement image of an enterprise are uploaded using a smartphone to a controller of a shadow advertisement system, so a shadow advertisement is projected using a streetlight via a LED light source, a lens, an advertisement film made of a transparent material, whereupon a shadow advertisement containing a logo, brand and advertisement image of an enterprise can be conveniently provided at an outdoor space, for example, an exhibit hall, a streetlight, a bus stop, a shelter, etc., and it can be used in such a way to project on a floor surface or a wall surface of a large size mart, a building parking lot of a department store, a direction indication lamp inside a building, a company guide device, etc.

The shadow advertisement system using a streetlight wherein the electric power of the streetlight is driven by a sunlight module and a charge controller according to the present invention will be described in detail.

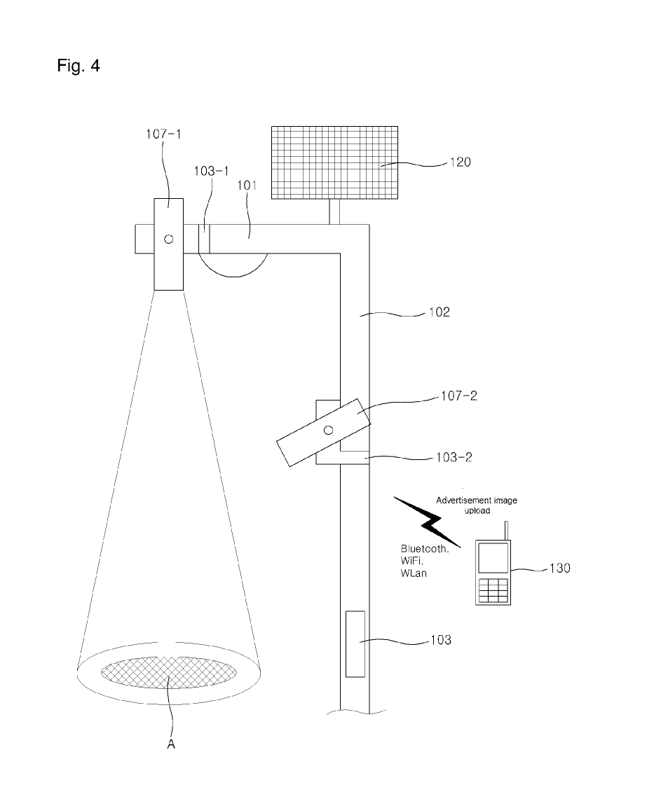

FIG. 4 is a view illustrating the configuration of a shadow advertisement system wherein the electric power of the streetlight is driven by a sunlight module and a charge controller, and an advertisement image is uploaded from an advertisement image according to a second embodiment of the present invention.

FIG. 4 shows a luminaire-integrated shadow advertisement system.

A display device 107-1, 107-2 which includes a shadow advertisement controller and a shadow advertisement system both installed at a predetermined position away from an end portion of the luminaire 101 of the streetlight or the streetlight pole 102 is engaged by an engaging member, for example, a zig device 103-1, 103-2 which is provided to engage them at an installation position of the luminaire 101 of the streetlight or the streetlight pole 102, wherein if the advertisement image information of the advertisement film 30 may absorb the light source 10 and may be dispersed on the lens 20, the advertisement image information printed on the advertisement film 30 may be projected via the light which has passed through the lens 20, thus exposing a shadow advertisement image “A” at a predetermined position, whereby the continuous advertisement can be available.

Referring to FIG. 4, the luminaire-integrated shadow advertisement system is employing a method wherein it is designed to be integrated with the luminaire 101, thus providing a shadow advertisement using a streetlight, and it may be directly installed at the streetlight pole 102 without any zig device in such a way to integrally assemble a lens 1, an image cell (a film, and a panel), a lens 2, a lens 3, a heating device, etc.

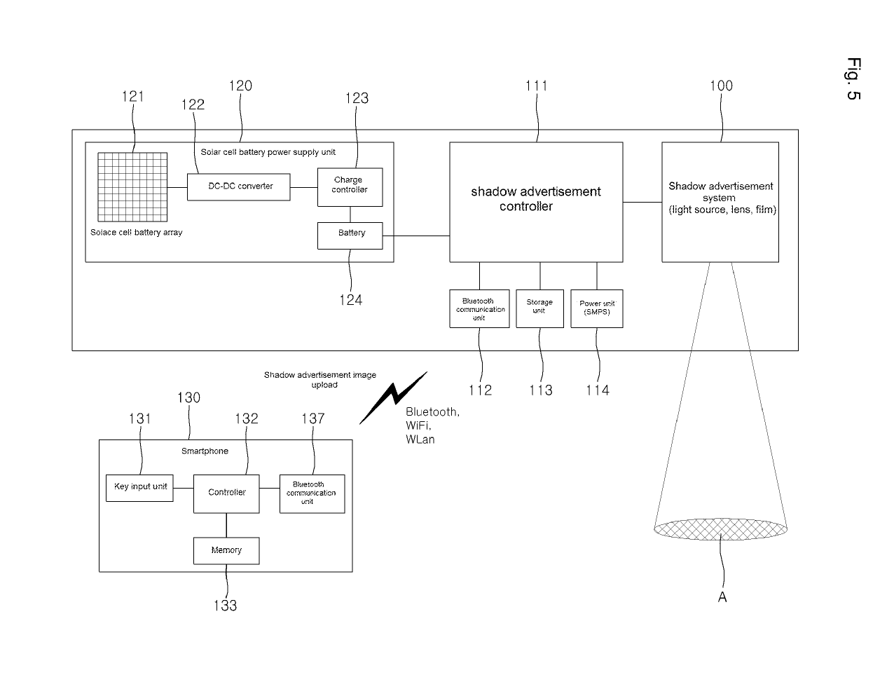

FIG. 5 is a view illustrating the configuration of a shadow advertisement system wherein the electric power of a streetlight is driven by a sunlight module and a charge controller, and an advertisement image is uploaded from a smartphone according to a second embodiment of the present invention.

The shadow advertisement system wherein the electric power of a streetlight is driven by a sunlight module and a charge controller, and an advertisement image is uploaded from a smartphone via Wi-Fi, Bluetooth or WLAN may include, but is not limited to, a solar battery power supply unit 120 wherein a constant DC voltage and DC current can be supplied to a shadow advertisement controller 111 and a shadow advertisement system 100 by converting a solar energy from the sunlight module based on a DC-DC conversion; a shadow advertisement controller 111 which is able to receive an advertisement image uploaded from a smartphone via a wireless communication unit, for example, Wi-Fi, Bluetooth, WLAN, etc. and set an advertisement time; and a shadow advertisement system 100 which is able to projecting a shadow advertisement printed on a film in such a way to project a light source, a lens, and an advertisement film which operates in linkage with the lighting circuit. The advertisement printed on the advertisement film can be projected via the light which has passed through the lens after the light source is received and projected via the lens, whereby the shadow advertisement can be exposed at a predetermined position.

The shadow advertisement controller 111 may include, but is not limited to, a controller 112 which is able to control the shadow advertisement to be projected; a wireless communication unit (Bluetooth, Wi-Fi, WLAN) 113 which is connected to the controller 112 and wherein a shadow advertisement image and advertisement time information is wirelessly uploaded from the smartphone 130 by a shadow advertisement controller via a wireless communication (Bluetooth, Wi-Fi, WLAN), a storage unit 113 which is connected to the controller 112 and is able to store the shadow advertisement image and the advertisement time information which are uploaded from the smartphone 130; an electric power unit (SMPS power unit) 114 which is able to supply the AC power in the form of a DC power; and a timer (not illustrated) which is connected to the controller 112 and is configured to count the time.

The shadow advertisement controller 111 is able to receive and store the advertisement image uploaded by an external smartphone and control the advertisement image to be projected at a set time, and the wireless communication unit is configured to use any wireless communication method selected from Wi-Fi, Bluetooth, and a wireless LAN.

The streetlight device or the shadow advertisement controller 111 may include a CdS cell power driving unit (a CdS sensor) which is configured to automatically turn on the electric power of the streetlight if luminance becomes low at an evening time and a deep night time or if the illuminance drops below a reference value of a constant illumination value and turn off the electric power of the streetlight if it is a day time or it rises above a predetermined illuminance value at a day time.

At this time, the shadow advertisement controller 111 may include a CdS cell power driving unit (a CdS sensor) which is connected to the shadow advertisement controller and is configured to automatically turn on the electric power of the streetlight if illuminance becomes low at an evening time and a deep night time or if the illuminance drops below a predetermined reference value of a constant illuminance value and turn off the electric power of the streetlight if the illuminance becomes high since the illuminance rises over a predetermined illuminance value at a lunch time. In this case, the controller 112 is configured to drive a light source driving unit in response to a power on/off state of the CdS cell power driving unit (a CdS sensor).

Moreover, the shadow advertisement controller 111 is configured to receive an advertisement image after it is connected to an external server via the wireless communication unit.

In the shadow advertisement system 100, a plurality of LEDs 10 are disposed in series. The straight light of the LEDs 10 are converged at the lens 20, thus projecting the advertisement printed on the advertisement film 30 and expressing a shadow advertisement image “A”. The shadow advertisement system 10 using a streetlight may include a light source 10 which is able to emit light; a lens 20 which is fixed spaced apart by a predetermined distance from an advertisement film 30 and has a predetermined radius of curvature; and an advertisement film 30 which is made of a transparent material and is configured to converge the straight light from the light source into the lens and project an advertisement of the film. The lens may be any of a convex lens and a concave lens or may be made by forming a convex lens made of another material at a plane lens or a curved lens. If the advertisement of the advertisement film 30 is projected via the light source 10 and is dispersed at the lens 20, the advertisement printed on the advertisement film 30 is projected via the light which has passed via the lens 20, thus exposing a shadow advertisement image at a predetermined position.

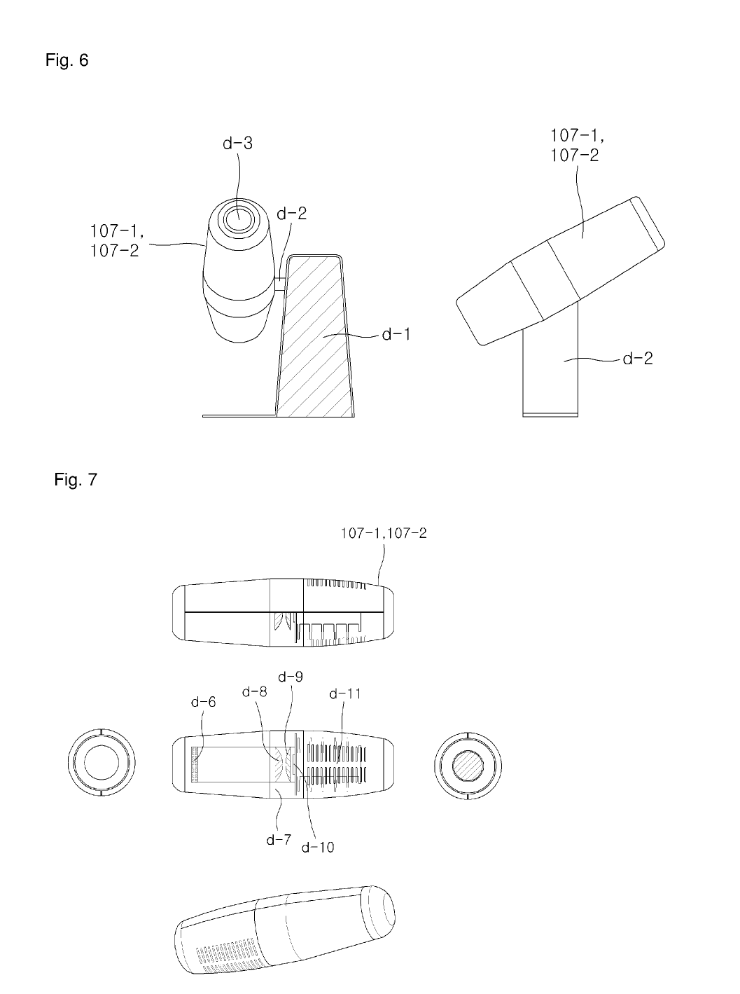

FIGS. 6 and 7 are views illustrating a shadow advertisement display device which is implemented into a product which contains a shadow advertisement controller and a shadow advertisement system.

The shadow advertisement system may be manufactured integral with a shadow advertisement controller or may be manufactured in the form of a separate device.

The electric power of the shadow advertisement system may be supplied by connecting an electric power cable to the luminaire 101 of the streetlight or the streetlight pole 102 using an electric power cable which extends from the ground just below the streetlight. The shadow advertisement system, if necessary, may use a SMPS power device.

The shadow advertisement system equipped with a shadow advertisement controller according to the present invention is a device which can apply to an advertisement technology which can be implemented using a streetlight and may include an power supply unit (SMPS) (d-1), a connection member (d-2) and a light source driving unit. The power supply unit (d-1) may be connected via an electric power supply connection cable to the light source driving unit using a connection member.

Referring to FIG. 7, the light source driving unit is a device wherein a focal distance adjusting lens 1 (d-6), an image cell (a film and a display panel) (d-7), a convex lens 2 (d-8), a concave lens 3 (d-9), at least one or more light sources (LED, HQI, a lamp, etc.) (d-10) and a cooling unit (d-11) for cooling the heating of the light source device, which all are assembled at a front thereof based on a designing. This device is equipped with a protection function of above IP60.

The image cell (d-7) may correspond to an analog expression method as a first film in two methods, wherein the film of the image cell may be a light shield plate (gobo) wherein an ink is printed on a film plate made of a glass and a chrome material or may be a light shield plate (gobo) which is formed of an ordinary iron or steel.

Second, an advertisement image may be transmitted using a PCB and a DC power supply device with the aid of a digital display panel (TFT LCD). The shadow advertisement image may be transmitted by connecting a PC and a communication unit of a smartphone using a separate advertisement server via a wireless communication unit of a shadow advertisement controller.

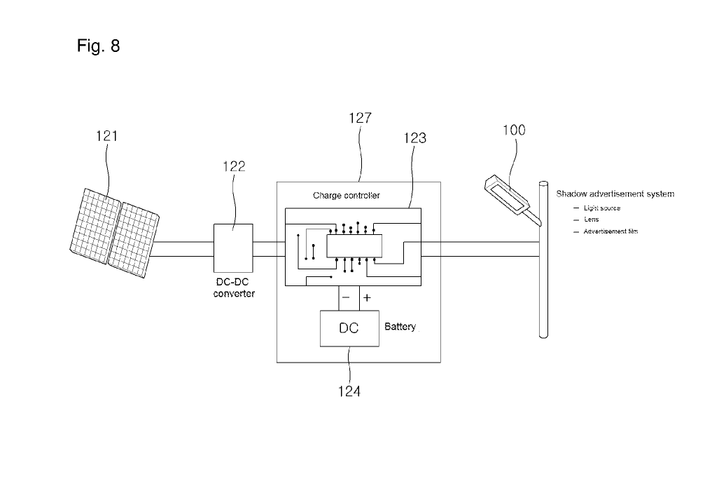

FIG. 8 is a view illustrating the configuration of a sunlight streetlight driven by a solar battery module.

The sunlight streetlight driven by a solar battery module may be driven by a sunlight module 121, a DC-DC converter 122, a charge controller 127 and a battery (a storage battery) 124 provided in a control box 127, and an inverter (not illustrated).

The sunlight module 121 may be formed of a solar cell array (a solar module array, PV array) which is equipped with a Plannel lens for the sake of light condensation and uses a PN junction semiconductor. If the solar energy condensed via the Plannel lens is transmitted to the solar cell arrays disposed in multiple arrangements, the solar energy can be converted into electric energy based on a photo-voltaic effect, thus generating a DC current and a DC voltage. For reference, if sunlight is inputted into a PN junction unit of the solar cell, electrons may be attracted toward an upper electrode, and holes may be attracted toward a lower electrode, by which a photoelectro-motive force may occur between two electrodes based on the photo-voltaic effect, whereby a DC current and a DC voltage can be generated in proportion to the photon flux density.

In the sunlight module 121, a small-scale PV power system is able to store the capacity of a solar battery of below 100 kWp.

The charge controller 123 may include an overcharge/over discharge prevention circuit which is able to directly supply a DC current generated by the sunlight module 121 to a load or receive a DC current and voltage (+, −) from the sunlight module 121 with the aid of the charge controller 123 and charge it into the battery (a storage battery) 124. The overcharge/over discharge prevention circuit may provide a function for preventing an overcharge and over discharge which may occur dependent on the capacity of the storage battery when charging or discharging the DC current and voltage supplied from the charge controller 123. As for the overcharge, if the voltage at the storage battery rises over a predetermined level, corrosion may occur at the storage battery, and gas may generate, which may result in a decreased service life. As for the over discharge, if the storage capacity of the storage battery drops below a predetermined voltage (for example, DC23V), sediment may produce at the storage battery, and the performance of the storage battery may be gradually degraded.

The battery (a storage battery) 124 is able to convert an electric energy into a chemical energy and charge it, and on the contrary, the battery may discharge during the supply of the electric energy to the load.

The battery 124 (a storage battery) used for the charge of the sunlight is a secondary cell battery and is any of a lead-acid battery and a nickel-cadmium battery.

There may be provided an inverter, if necessary, and the inverter is connected to the charge controller 123. The inverter is able to convert an alternating current (AC) into a direct current (DC), and on the contrary, it may convert the DC into the AC.

98% of the currently used solar cell battery is a single crystal silicon solar cell battery, which uses a super purity semiconductor. The high efficiency of the solar cell battery may be obtained using a poly crystal thin film silicon solar cell battery, for example, a poly crystal silicon (poly-Si), an amorphous silicon (a-Si), etc. As a technology for depositing a high quality crystalline thin film, there may be a chemical vapor deposition method (a CVD method), a liquid phase epitaxy (a LPE method), and a solid phase crystallization method (a SPC method), which are currently being developed.

The shadow advertisement system controlled in linkage with the smartphone according to the present invention may include a light source which is able to emit light, an image cell connected to the light source, and a shadow advertisement controller which is able to transmit an advertisement image information to the image cell in order for the advertisement image to be projected via the lens using the light source, and a beam projector may be installed at a streetlight, whereby the advertisement image information can be expressed in the form of a shadow advertisement image at a predetermined position with the aid of the light source.

The shadow advertisement method controlled in linkage with the smartphone according to the present invention may include, but is not limited to, a step wherein an advertisement information containing an advertisement image and/or an advertisement time and position of a member is received by a shadow advertisement controller from a smartphone or a computer via a wireless communication unit, and the thusly received information is stored; and a step wherein an advertisement image information printed on an advertisement film made of a transparent material projected via the light source and the lens by means of the shadow advertisement controller and the shadow advertisement system is projected via the light which has passed via the lens, thus exposing the shadow advertisement image at a predetermined position.

The shadow advertisement method controlled in linkage with the smartphone may further include a step wherein an advertisement member subscription information is transmitted from the smartphone or the computer to an advertisement server via the wireless communication unit, and a login is carried out.

In the shadow advertisement system and the method thereof which are controlled in linkage with a smartphone according to the present invention, electric power is supplied to a streetlight(LED lighting) with the aid of a SMPS electric power, a sunlight module and a charge controller, and a logo and advertisement image of an enterprise are uploaded using a smartphone to a controller of a shadow advertisement system, so a shadow advertisement is projected using a streetlight via a LED light source, a lens, an advertisement film made of a transparent material, whereupon a shadow advertisement containing a logo, brand and advertisement image of an enterprise can be conveniently provided at an outdoor space, for example, an exhibit hall, a streetlight, a bus stop, a shelter, etc., and it can be used in such a way to project on a floor surface or a wall surface of a large size mart, a building parking lot of a department store, a direction indication lamp inside a building, a company guide device, etc.

It is expected that the LED lighting market and the outdoor advertisement market belonging to the shadow advertisement system which uses a streetlight according to the present invention will steadily grow until 2020.

Moreover, the shadow advertisement place my increase the frequency of advertisement exposures if it is determined based on a price setting criteria by selecting the place crowed with a lot of floating population that the owners of advertisements like after the position by floating population has been confirmed.

The decision of such a place may be decided after a discussion with the owner of the advertisement (if another company is using it, the decision may change based on the contents of the contract).

Moreover, the staff inside the company may advertise in person the contents on the streetlight advertisement while searching for the owners of the advertisements, and the advertisement exposure frequency data may be continuously updated, and the updated data can be periodically provided, whereby good reliability can be constructed, and the advertisement can be continuously provided.

The aforementioned method according to the present invention may be implemented in the form of a program and may be stored in a recording medium (CD-ROM, RAM, ROM, a memory card, a hard disk, a magneto-optical disc, a storage device, etc.) which can be readable using a computer software.

As described above, the present invention has been described with reference to the preferred embodiments. It, however, is obvious that a person having ordinary skill in the art is able to variously modify or change the present invention without departing from a technical concept and scope of the present invention recited in claims.

### INDUSTRIAL APPLICABILITY

In the shadow advertisement system and the method thereof which are controlled in linkage with a smartphone according to the present invention, electric power is supplied to a streetlight(LED lighting) with the aid of a SMPS electric power, a sunlight module and a charge controller, and a logo and advertisement image of an enterprise are uploaded using a smartphone to a controller of a shadow advertisement system, so a shadow advertisement is projected using a streetlight via a LED light source, a lens, an advertisement film made of a transparent material, whereupon a shadow advertisement containing a logo, brand and advertisement image of an enterprise can be conveniently provided at an outdoor space, for example, an exhibit hall, a streetlight, a bus stop, a shelter, etc., and it can be used in such a way to project on a floor surface or a wall surface of a large size mart, a building parking lot of a department store, a direction indication lamp inside a building, a company guide device, etc.

In the shadow advertisement system and method thereof according to the present invention, it is possible to directly enter the conventional outdoor advertisement market in such a way to conveniently advertise the enterprise's logo and brand printed on the advertisement film made of a transparent material, and the LED lighting market can be further developed, and a continuous advertisement effect can be provided by periodically projecting on the shadow advertisement system the advertisement data which are automatically and wirelessly updated via the smartphone.

Moreover, the principle of the technology of the present invention may be employed to a home fluorescent lamp or a stand lamp in order to provide a smooth and advanced shadow advertisement by exposing a logo, a text or an advertisement image, so it is possible to provide an enhanced service function to a lighting device that a customer is using, in a shadow advertisement light market equipped with new lighting devices.

1. A shadow advertisement system which is controlled in linkage with a smartphone, comprising:
a power supply unit for, in DC-DC conversion of solar energy from a photovoltaic module, supplying a constant DC voltage and DC current or using an SMPS power source;
a shadow advertisement controller for receiving, via a smartphone and a wireless communication means, an upload of an advertisement image and setting an advertisement time; and
a shadow advertisement system for projecting a shadow advertisement printed on a film through a light source, a lens and an advertisement in linkage with a lighting circuit and exposing the shadow advertisement, wherein the shadow advertisement is exposed at a certain location in such a manner that the light source is delivered to and penetrates the lens, and the advertisement printed on the advertisement film is projected by light which has passed through the lens.

2. The system of claim 1, wherein the power supply unit uses a solar cell battery power supply unit or a SMPS power supply unit and is configured to operate in a hybrid method by means of the shadow advertisement controller.

3. The system of claim 1, wherein the shadow advertisement controller controls the advertisement image to be uploaded from an external PC (Personal Computer) or the smartphone and to be stored, thus projecting an advertisement image at a set time, and the wireless communication means uses any wireless communication method selected among Wi-Fi, Bluetooth, and a wireless LAN.

4. The system of claim 1, wherein the shadow advertisement controller comprises:
a controller which controls the shadow advertisement to be projected;
a wireless communication unit (Bluetooth, Wi-Fi, WLAN) which is connected to the controller and is able to wirelessly receive, based on the shadow advertisement controller, a shadow advertisement image and an advertisement time information from the smartphone via a wireless communication (Bluetooth, Wi-Fi, WLAN);
a storage unit which is connected to the controller and is configured to store the shadow advertisement image and the advertisement time information which are uploaded from the smartphone;
an electric power unit (a SMPS power unit) which is able to supply an AC power in the form of a DC power; and
a timer which is connected to the controller and is configured to count time.

5. The system of claim 4, wherein the shadow advertisement controller comprises a CdS cell power driving unit (a CdS sensor) which is connected to the controller and is configured to automatically turn on the electric power of the streetlight if illuminance becomes low at an evening time and a deep night time or if the illuminance drops below a predetermined reference value of a constant illuminance value and turn off the electric power of the streetlight if the illuminance becomes higher than a predetermined illuminance value at a lunch time, and in this case the controller is configured to drive the light source driving unit in response to an on/off operation of the CdS cell power driving unit (a CdS sensor).

6. The system of claim 1, wherein the shadow advertisement controller is connected to an external server via the wireless communication means and receives the advertisement image and the advertisement time information.

7. The system of claim 1, wherein the shadow advertisement system comprises:
a light source which is able to emit light;
a lens which is fixed spaced apart by a predetermined distance from the advertisement film and has a predetermined radius of curvature; and
an advertisement film which is made of a transparent material and is configured to converge the straight light from the light source at the lens and project the advertisement of the film, wherein the lens is any of a convex lens and a concave lens or a convex lens made of another material can be shaped on a plane lens or a curved lens, and if the advertisement of the advertisement film absorbs the light source and is dispersed on the lens, the advertisement printed on the advertisement film is projected via the light which has passed through the lens, thus exposing a shadow advertisement at a predetermined position.

8. The system of claim 1, wherein the shadow advertisement system comprises:
a light source which is able to emit light;
a lens which is fixed spaced apart by a predetermined distance from the advertisement film and has a predetermined radius of curvature; and
an advertisement film which is made of a transparent material and is configured to converge the straight light from the light source at the lens and project the advertisement of the film, wherein the lens is any of a convex lens and a concave lens or a convex lens made of another material can be shaped on a plane lens or a curved lens, and if the advertisement of the advertisement film absorbs the light source and is dispersed on the lens, the advertisement printed on the advertisement film is projected via the light which has passed through the lens, thus exposing a shadow advertisement at a predetermined position.

9. A shadow advertisement method which is controlled in linkage with a smartphone, comprising:
a step wherein an advertisement information containing an advertisement image and/or an advertisement time and position of a member is received by a shadow advertisement controller from a smartphone or a computer via a wireless communication unit, and the thusly received information is stored; and
a step wherein an advertisement image information printed on an advertisement film made of a transparent material projected via the light source and the lens by means of the shadow advertisement controller and the shadow advertisement system is projected via the light which has passed via the lens, thus exposing the shadow advertisement image at a predetermined position.

10. The method of claim 9, further comprising:
a step wherein an advertisement member subscription information is transmitted from the smartphone or the computer to an advertisement server via the wireless communication unit, and a login is carried out.
